(19) United States
(12) Patent Application Publication
(10) Pub. No.: US 2005/0206835 A1
(43) Pub. Date: Sep. 22, 2005

(54) Spectacle assembly

(76) Inventor: Chow Leung Tony Cheng, Hong Kong (HK)

Correspondence Address: CHENG CHOW LEUNG, TONY, FLAT 4A, BLOCK 1, REDLAND GARDEN, TAI PO, HK

(21) Appl. No.: 11/011,179

(22) Filed: Dec. 15, 2004

Related U.S. Application Data
(60) Provisional application No. 60/554,909, filed on Mar. 22, 2004.

(51) Int. Cl. G02C 9/00; G02C 7/08

(52) U.S. Cl. 351/57

(57) ABSTRACT

A grip-on eyeglass device is designed for mounting auxiliary eyeglasses onto primary spectacle frame by using a single plastic grip. The plastic grip, constructed at the nasal area on the rear side of the auxiliary eyeglasses, is designed to plug with its corresponding socket located behind the bridge of the primary spectacle frame or to plug directly with the built-in recesses formed on top and bottom sides of the bridge of another primary spectacle frame, bringing the auxiliary eyeglasses into attachment with two options of primary spectacle frames. The assembly is perfect because the two legs of the grip are made with bulging heads while its corresponding socket is made recessed, making clamping action effective when they come into attachment. The attaching process is easy, yet the bond is so strong that it avoids any possible detachment or downward movement of the auxiliary eyeglasses from the primary spectacle frame. Elimination of using extra metal attaching accessories keeps the eyeglasses light and its appearance neat.

This patent application claims the benefit of the filing date of my provisional patent application, 60554909, filed on Mar. 22, 2004.

### FIELD OF THE INVENTION

The present invention relates to spectacle assemblies, and in particular spectacle assemblies having a primary spectacle frame and at least one pair of releasably engageable auxiliary eyeglass.

### BACKGROUND OF THE INVENTION

Clip-on spectacle frame system is popular because it allows the users to expand the functions of spectacles easily and conveniently. For example, a pair of sunglasses can be attached onto a pair of reading glasses and vice versa. Many proposals have been made for various kinds of clips, with or without magnet, making clip-on auxiliary eyeglasses possible to be detachably attached to a primary spectacle frame. The success of various kinds of clips varies in terms of security of attachment, non-intrusive appearance and ease of attachment/detachment.

Magnetic clips have been popular recently as a connecting means in various arrangements, such as one disclosed in U.S. Pat. No. 5,416,537. Provided with no actual physical support, the disengagement of auxiliary eyeglasses from primary spectacle frame, caused by gravity force during strenuous activity, is always a matter of concern.

Therefore, some sorts of physical support are provided in other arrangements, such as those disclosed in U.S. Pat. Nos. 5,940,162 and 6,343,858. Yet, the improvement is minimal because magnetic force will gradually weaken with the inevitable problems such as oxidization of magnet (in particular caused by sweating of the user) and stain accumulation in magnet holder (the stain and dirt hidden in the holder hinder direct contact of the magnets). These problems, resulted in deterioration of magnetic force and poor contact, give rise to unreliable bonding between auxiliary eyeglasses and primary spectacle frame. Moreover, magnets are attached onto the frames or sockets by gluing. If they become detached from their places, proper re-attachment of magnets requires a certain degree of techniques and facilities (industrial glue and oven are necessary) which may be difficult for an ordinary user.

Conventional clip-on systems (with or without magnet) as described in U.S. Pat. Nos. 5,696,571, 6,343,858, 6,540,348 require a pair of auxiliary eyeglasses to be supported with rim-wire so that hooks, temple extension devices and other auxiliary attaching appendages can be constructed thereon for effective mating of the auxiliary eyeglasses with the primary spectacle frame. The existence of these accessories and a double set of rim-wire negatively affect the appearance of and add weight to the frame, which in turn cause discomfort to users.

Although rimless design of auxiliary eyeglasses is provided in such arrangement as that disclosed in U.S. Pat. No. 6,341,864, the visibility of the hooks or clips as they are formed on the auxiliary lenses blemishes the general appearance of the frame. These hooks and clips may also cause scratches on the primary frame and/or its prescription lenses.

All the above mentioned conventional clip-on systems usually involve one to two pairs of clips and hooks which makes the fit on process time-consuming and difficult.

### SUMMARY OF THE INVENTION

According to a first aspect of the present invention, there is provided a spectacle assembly including a spectacle fame; and a pair of auxiliary eyeglasses releasably attachable with said spectacle frame; wherein said pair of auxiliary eyeglasses include at least a first resilient engagement member snap-fittable with said spectacle frame.

According to a second aspect of the present invention, there, is provided a method of forming a spectacle assembly, including the steps of providing a spectacle frame; providing a pair of auxiliary eyeglasses releasably attachable with said spectacle frame; and providing a first resilient engagement member on said pair of auxiliary eyeglasses for snap-fitting with said spectacle frame.

It is a main object of the present invention to provide an improved eyeglass assembly and a method for attaching a pair of auxiliary eyeglasses to a primary spectacle frame by using a single plastic grip so that the pair of auxiliary eyeglasses can be securely attached to or detached from the primary spectacle frame with ease, while keeping the aesthetic design of the respective eyeglasses.

The plastic grip, located at the nasal area on the rear side of the pair of auxiliary eyeglasses, is designed and made to grip with a corresponding plastic socket behind the bridge of a primary spectacle frame; or to grip with a corresponding built-in recesses formed on the top and bottom sides of the bridge of a primary spectacle frame, bringing the pair of auxiliary eyeglasses into attachment with primary spectacle frames of different designs. The assembly is perfect because two legs of the grip are made with bulging heads while its corresponding socket or bridge, which is provided with recesses on two contact sides, are adapted to solidly fit with the bulging heads of the grip. As the grip, the socket and the bridge with built-in recesses are made of plastics material, given the elasticity of the plastics materials, they can be perfectly matched and give rise to clamping action which automatically aligns and secures the auxiliary eyeglasses with the primary spectacle frame.

The present invention, disposing of the use of magnet, finds great improvement in the issue of bonding. The clamping action makes the bond so strong that it avoids any possible detachment or downward movement of the auxiliary eyeglasses from the primary spectacle frames, which might be caused by gravity force during strenuous activity.

The present invention involves no extra hooks, temple extension devices or other attaching accessories. The appearance of the primary spectacle frame stays clean and neat because the plastic socket, being fixed by screws from the backside of the bridge, is confined within the edges of the bridge, which makes itself invisible from the front view of the primary spectacle frame.

Even when the pair of auxiliary eyeglasses are attached onto the primary spectacle frame, the plastic grip, being mounted on the rear side of the auxiliary eyeglasses, is hardly detectable from the front view of the spectacle set. Individuality of the respective eyeglasses is maintained due to the non-existence of those conventional extra attaching accessories.

Besides, the chance of scratching the primary spectacle frame and/or its prescription lenses is minimized through elimination, of metal appendages. And due to the plastic nature of the grip, the impact, if any, is much weaker than the metal appendages of conventional designs.

In respect to the ease of handling, the mounting means of the present invention involves only a single grip, users, by holding the edge of the pair of auxiliary eyeglasses with one hand, can easily plug in the grip without removing the spectacle frame from the face. The orientation is almost automatic that the grip can smoothly slide onto the recessed socket or recessed bridge.

Additionally, the present invention uses screws to secure the grip and socket on their places, if they become loose or separable, one can fix them back by screwing and will find the installation process easy.

Detailed features and operation of the present invention will become apparent from a careful reading of a detailed description provided below, with appropriate reference to accompanying drawings.

### BRIEF DESCRIPTION OF THE DRAWINGS

FIG. 1 is a back perspective view of a pair of auxiliary eyeglasses according to a first embodiment of the present invention.

FIG. 1A is an enlarged view of the grip shown in FIG. 1.

FIG. 2 is a back perspective view of a first primary spectacle frame for engagement with the pair of auxiliary eyeglasses shown in FIG. 1.

FIG. 2A is an enlarged view of the socket shown in FIG. 2.

FIG. 3 is a rear perspective view of the pair of auxiliary eyeglasses shown in FIG. 1 as mounted onto the primary spectacle frame shown in FIG. 2.

FIG. 3A is an enlarged view showing the engagement between the grip shown in FIG. 1A and the socket shown in FIG. 2A.

FIG. 4 is a front perspective view of the primary spectacle frame shown in FIG. 2.

FIG. 5 is a front perspective view of the pair of auxiliary eyeglasses shown in FIG. 1 as mounted onto the primary spectacle frame shown in FIG. 2.

FIG. 6 is a back perspective view of a pair of auxiliary eyeglasses according to a second embodiment of the present invention.

FIG. 6A is an enlarged view of the grip shown in FIG. 6.

FIG. 7 is a back perspective view of a second primary spectacle frame for engagement with the pair of auxiliary eyeglasses shown in FIG. 6.

FIG. 7A is an enlarged view of the socket shown in FIG. 7.

FIG. 8 is a rear perspective view of the pair of auxiliary eyeglasses shown in FIG. 6 as mounted onto the primary spectacle frame shown in FIG. 7.

FIG. 8A is an enlarged view showing the engagement between the grip shown in FIG. 6A and the socket shown in FIG. 7A.

FIG. 9 is a front perspective view of the primary spectacle frame shown in FIG. 7.

FIG. 10 is a front perspective view of the eyeglass assembly shown in FIG. 8.

FIG. 11 is a back perspective view of a pair of auxiliary eyeglasses according to a third embodiment of the present invention.

FIG. 11A is an enlarged view of the grip shown in FIG. 11.

FIG. 12 is a back perspective view of a third primary spectacle frame for engagement with the pair of auxiliary eyeglasses shown in FIG. 11.

FIG. 12A is an enlarged view of the bridge of the primary spectacle frame shown in FIG. 12.

FIG. 13 is a rear perspective view of the pair of auxiliary eyeglasses shown in FIG. 11 as mounted onto the primary spectacle frame shown in FIG. 12.

FIG. 13A is an enlarged view showing the engagement between the grip shown in FIG. 11A and the bridge shown in FIG. 12A.

FIG. 14 is a front perspective view of the primary spectacle frame shown in FIG. 12.

FIG. 15 is a front perspective view of the eyeglass assembly shown in FIG. 13.

FIG. 16 is a back perspective view of a pair of auxiliary eyeglasses according to a fourth embodiment of the present invention.

FIG. 16A is an enlarged view of the grip shown in FIG. 16.

FIG. 17 is a back perspective view of a fourth primary spectacle frame for engagement with the pair of auxiliary eyeglasses shown in FIG. 16.

FIG. 17A is an enlarged view of the socket of the primary spectacle frame shown in FIG. 17.

FIG. 18 is a rear perspective view of the pair of auxiliary eyeglasses shown in FIG. 16 as mounted onto the primary spectacle frame shown in FIG. 17.

FIG. 18A is an enlarged view showing the engagement between the grip shown in FIG. 16A and the socket shown in FIG. 17A.

FIG. 19 is a back perspective view of a pair of auxiliary eyeglasses according to a fifth embodiment of the present invention.

FIG. 19A is an enlarged view of the grip shown in FIG. 19.

FIG. 20 is a back perspective view of a fifth primary spectacle frame for engagement with the pair of auxiliary eyeglasses shown in FIG. 19.

FIG. 20A is an enlarged view of the bridge of the primary spectacle frame shown in FIG. 17.

FIG. 21 is a rear perspective view of the pair of auxiliary eyeglasses shown in FIG. 19 as mounted onto the primary spectacle frame shown in FIG. 20.

FIG. 21A is an enlarged view showing the engagement between the grip shown in FIG. 19A and the bridge shown in FIG. 20A.

FIG. 22 is a front perspective view of the primary spectacle frame shown in FIG. 20.

FIG. 23 is a front perspective view of the eyeglass assembly shown in FIG. 21.

### DETAILED DESCRIPTION OF PREFERRED EMBODIMENTS OF THE INVENTION

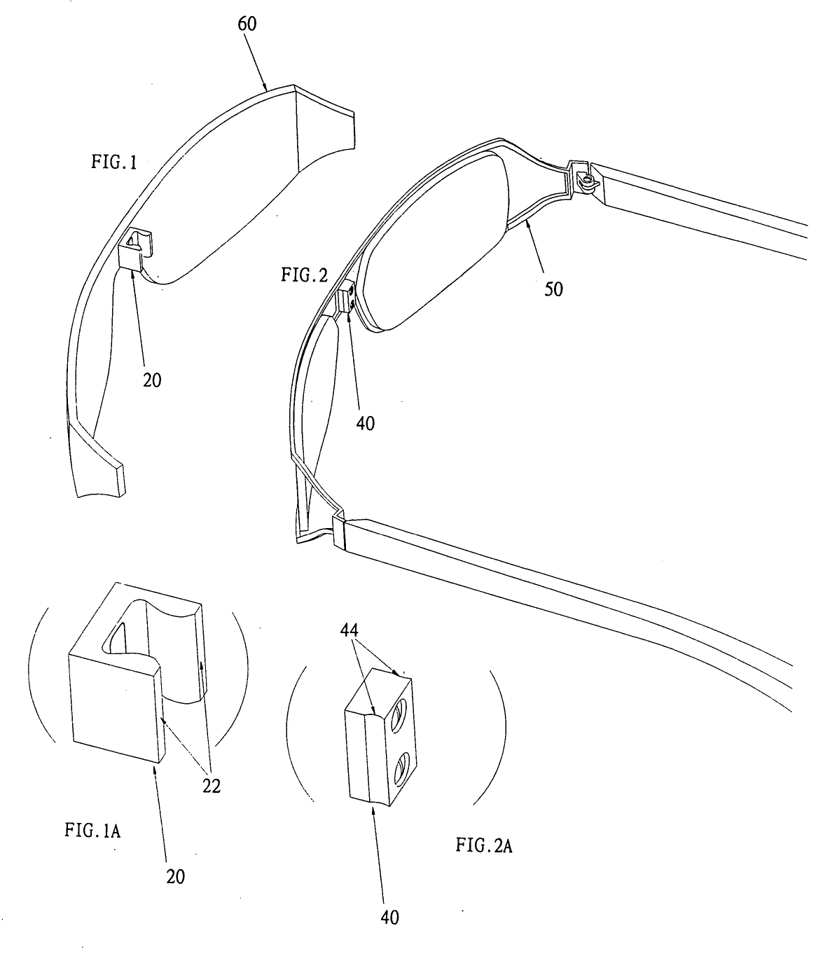

FIGS. 1-5 and FIGS. 6-10 are two sets of drawings showing the same mechanism but different directional preferred embodiments of the present invention. FIGS. 1-5 show a vertical design in which a plastic resilient grip 20 is provided on a pair of auxiliary eyeglasses 60 according to a first embodiment of the present invention, and a complementary plastic socket 40 and a bridge 30 are provided on a first primary spectacle frame 50, in which both the grip 20 and the socket 40 are located vertically; whereas FIGS. 6-10 show a horizontal design in which a plastic grip 125 on a pair of auxiliary eyeglasses 160 according to a second embodiment of the present invention, a complementary plastic socket 145 and a bridge 135 of a second primary spectacle frame 155 are located horizontally.

As FIGS. 1-5 and FIGS. 6-10 are of the same manner of operation, the illustration set forth below principally describes the vertical design; yet one can also understand the horizontal design by referring to the details quoted in the parentheses.

As shown in FIG. 1 (FIG. 6), a grip 20 (a grip 125) is located at the nasal area on the rear side of a pair of auxiliary eyeglasses 60 (auxiliary eyeglasses 160). The grip 20 (grip 125) appears in U-shape when viewed from a cross section. It comprises a rectangular base from which left and right sides (top and bottom sides for the grip 125) are erected with two resilient legs 22, 22 (legs 133, 133). Inward surfaces of the legs 22, 22 (legs 133, 133) are made curved with bulging heads. When the grip 20 (grip 125) plugs into recesses 44, 44 (recesses 166, 166) of the socket 40 (socket 145), clamping action becomes effective, making the bond between them strong enough to avoid downward movement and/or disengagement of the auxiliary eyeglasses 60 (auxiliary eyeglasses 160) from the primary spectacle frames during strenuous activities.

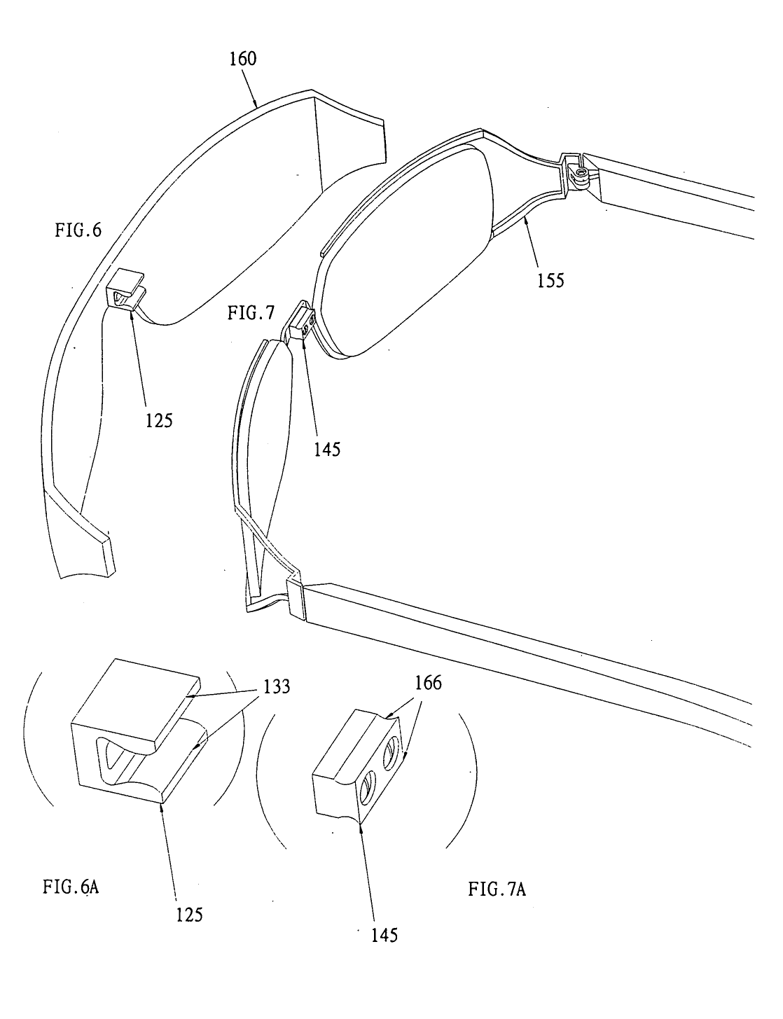

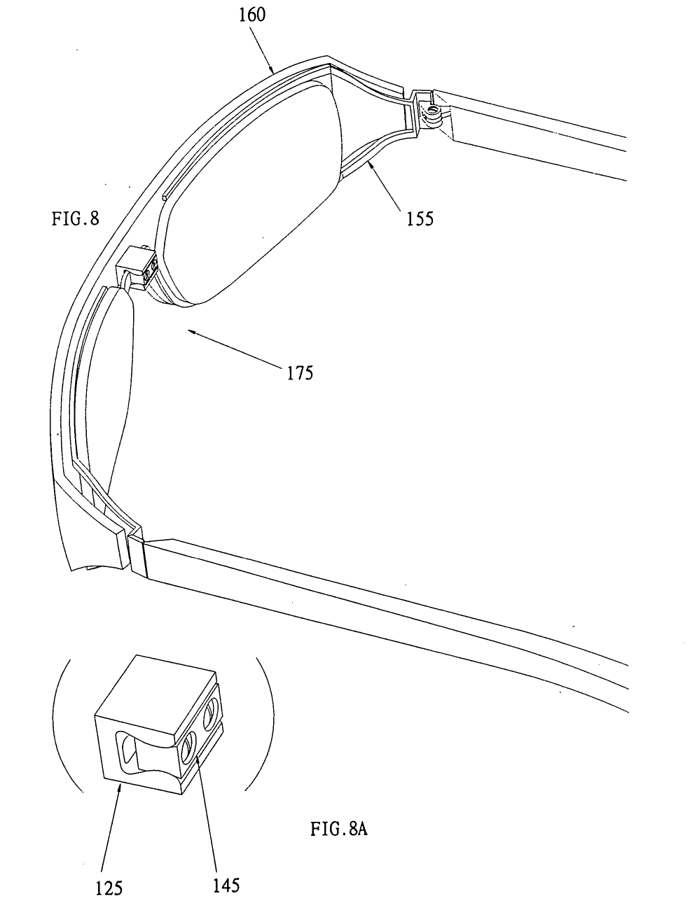

In FIG. 2 (FIG. 7), one can see that the socket 40 (socket 145) is located behind the bridge 30 (bridge 135) of a primary spectacle frame 50 (spectacle frame 155). The position of the socket 40 (socket 145) correspondingly matches with the grip 20 (grip 125). To allow clamping action, the two contact sides: left and right sides 44, 44 of the socket 40 (top and bottom sides 166, 166 of the socket 145) are recessed to receive legs 22, 22 of the grip 20 (legs 133, 133 of the grip 125).

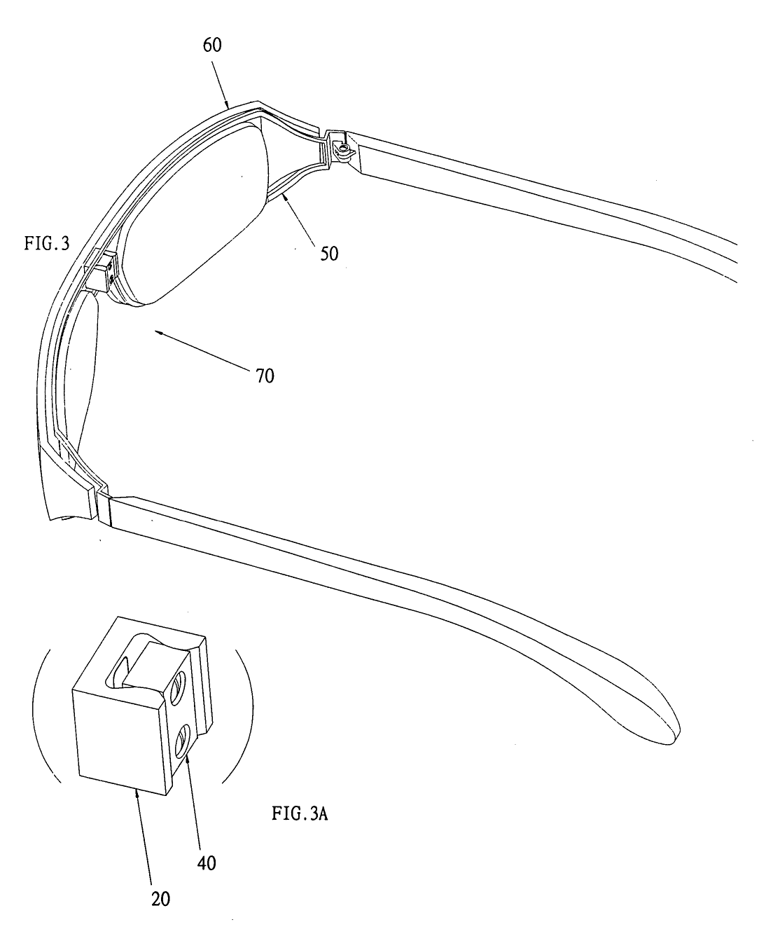

FIG. 3 (FIG. 8) shows a spectacle assembly 70 (spectacle assembly 175) formed of the auxiliary eyeglasses 60 (auxiliary eyeglasses 160) assembled with the primary spectacle frame 50 (frame 155). The spectacle frame 50 (spectacle frame 155) and the auxiliary eyeglasses 60 (auxiliary eyeglasses 160) are securely fastened together through the connection of the grip 20 (grip 125) and recessed socket 40 (socket 145). The clamping action completely avoids all possible slide off or disengagement issue caused by gravity force during strenuous activity.

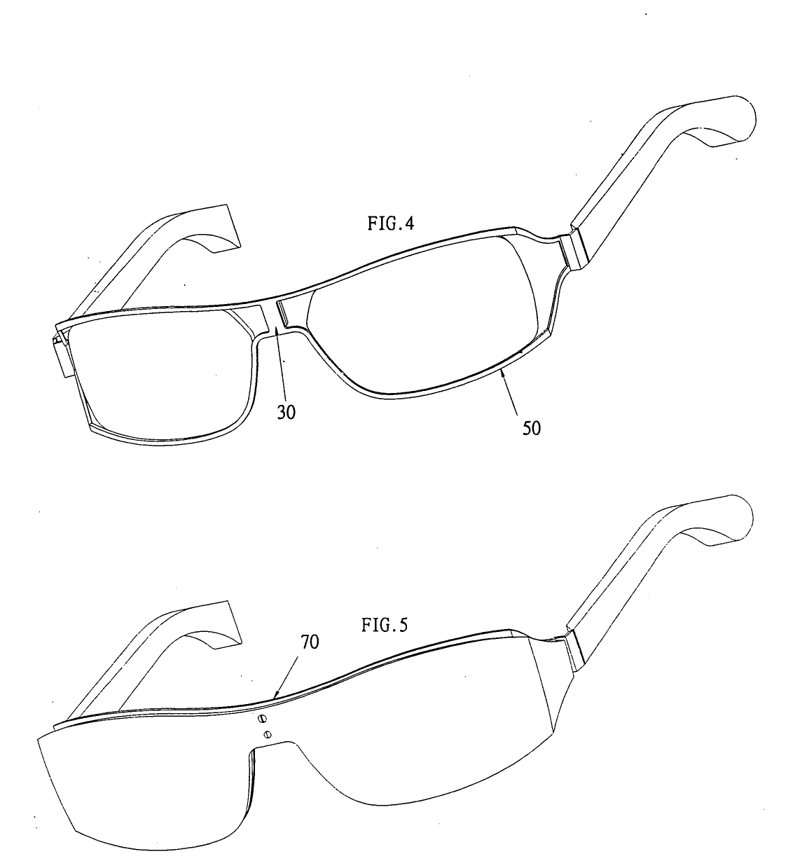

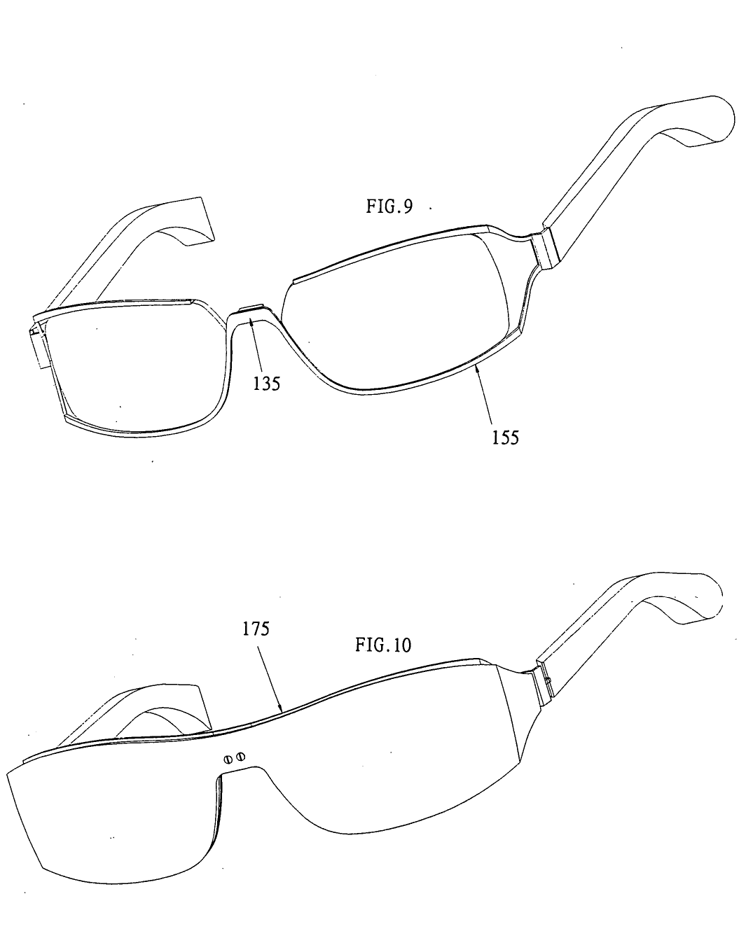

FIG. 4 (FIG. 9) is a front perspective view of the primary spectacle frame 50 (spectacle frame 155). The socket 40 (socket 145) is fixed by screws from the backside of the bridge 30 (bridge 135). As the edges of the socket 40 (socket 145) are confined within, i.e. do not exceed, the bridge 30 (bridge 135) of the frame 50 (frame 155), the socket 40 (socket 145) is invisible from a front view of the primary spectacle frame 50 (primary spectacle frame 155).

FIG. 5 (FIG. 10) is a front perspective view of spectacle assembly 70 (spectacle assembly 175). As the pair of auxiliary eyeglasses 60 (auxiliary eyeglasses 160) are a one piece sunshield lenses which contain no rim-wire, and/or any metal appendages (clips, hooks, magnets . . . ) constructed thereon or around the edges of the lenses, the appearances of the frame 50 (frame 155) as seen in FIG. 4 (FIG. 9) and the spectacle assembly 70 (spectacle assembly 175) as seen in FIG. 5 (FIG. 10) stay clean and neat. Individuality of the respective eyeglasses of FIG. 4 (FIG. 9) and FIG. 5 (FIG. 10) is maintained due to the non-existence of those conventional extra attaching accessories. Appearance of the primary frame 50 (frame 155) stays as its original with or without the attachment of the auxiliary eyeglasses; while the spectacle assembly 70 (spectacle assembly 175) will look like a pair of original sunglasses with the attachment of the one-piece sunshield lenses 60 (sunshield lenses 160).

In the embodiment shown in FIGS. 6-10, it can be seen that the resilient legs 133, 133 of the grip 125 have oppositely-facing inner surfaces which bulge towards each other, i.e. convex. These inner surfaces are designed for releasable engagement with the recesses 166, 166, which are concave outer surfaces, of the socket 145. A person skilled in the art would of course appreciate that the same engagement effect can be obtained if the oppositely-facing inner surfaces of the legs 133, 133 of the grip 125 are instead concave, whereas the outer surfaces of the socket 145 are convex, in order to allow the grip 125 and the socket 145 to be releasably engaged with each other.

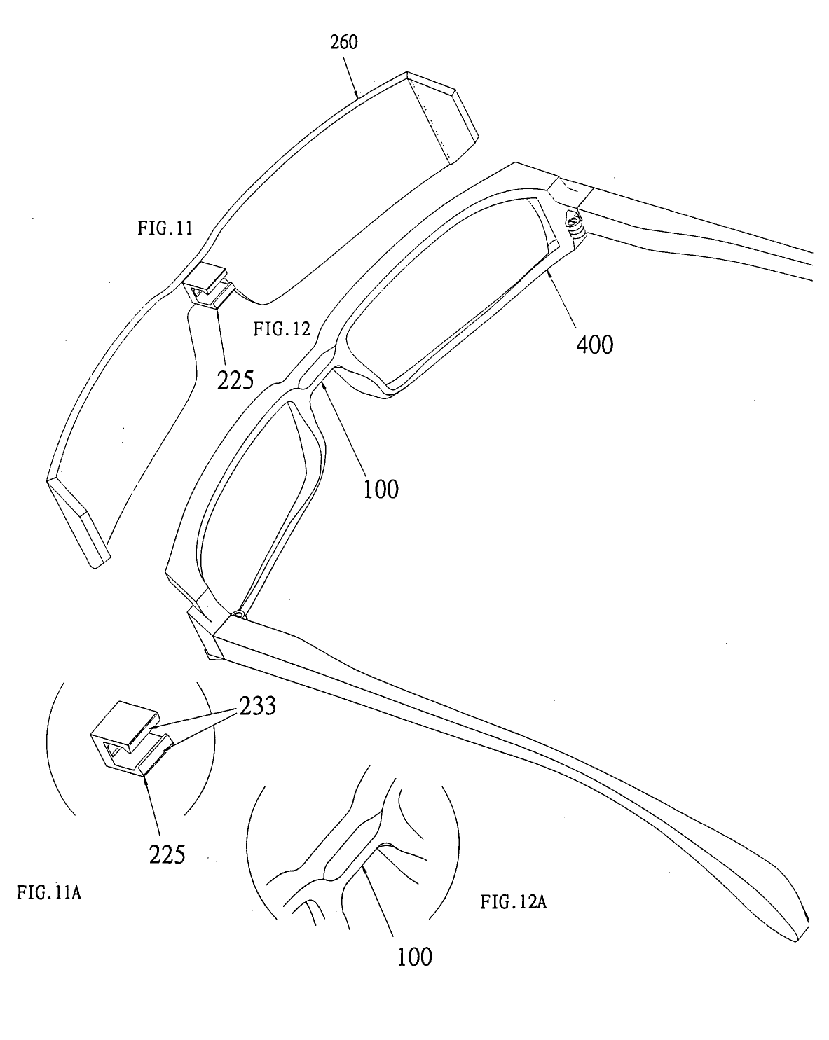

FIGS. 11-15 show a direct plug-in design according to a further preferred embodiment of the present invention comprising a horizontal plastic grip 225 on a pair of auxiliary eyeglasses 260, and a bridge 100 of a primary spectacle frame 400, with built-in recesses formed on the top and bottom sides. By plugging the grip 225 directly onto the bridge 100, the auxiliary eyeglasses 260 are releasably attached to the primary frame 400.

In FIG. 11, one can see that the grip 225 is located at the nasal area on the rear side of the auxiliary eyeglasses 260. The grip 225 appears in U-shape when viewed from a cross section. It comprises a rectangular base from which top and bottom sides are erected with two legs 233, 233. Inward surfaces of the legs 233, 233 are made curved with bulging heads. When the grip 225 is plugged onto the built-in recesses of the bridge 100, clamping action becomes effective and makes the bond between them strong.

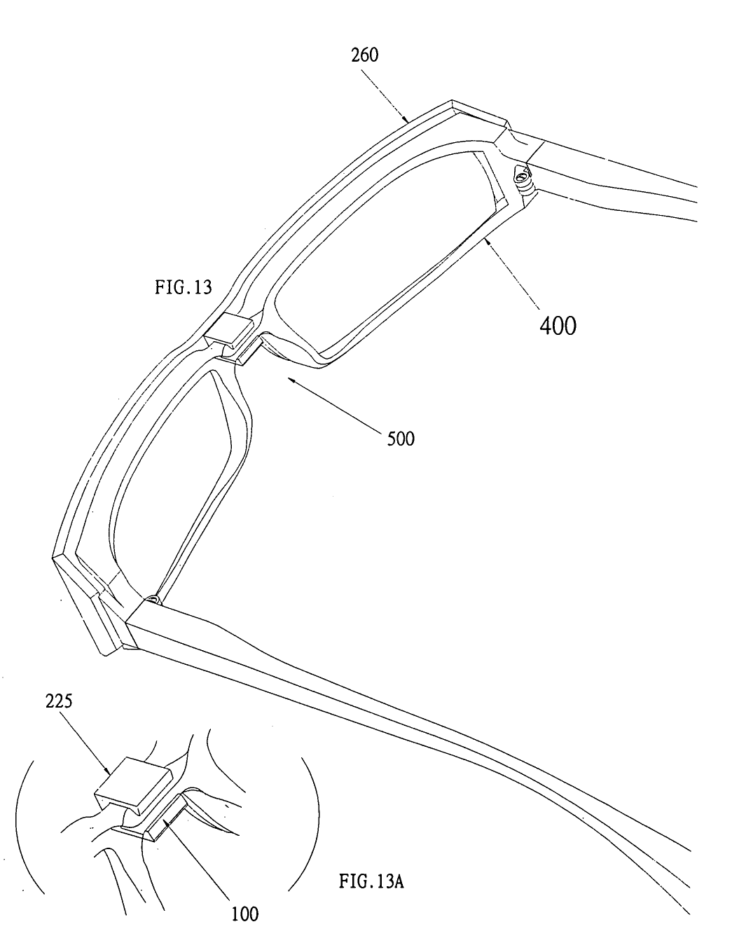

In FIG. 12 one can see that the bridge 100 of the primary spectacle frame 400 is recessed on the top and bottom sides to allow the grip 225 to plug on.

FIG. 13 shows a spectacle assembly 500 formed of the engagement between the pair of auxiliary eyeglasses 260 and the primary spectacle frame 400. The spectacle frame 400 and the auxiliary eyeglasses 260 are securely fastened together through the connection of the grip 225 with the bridge 100. The clamping action completely avoids all possible slide off or disengagement issue caused by gravity force during strenuous activity.

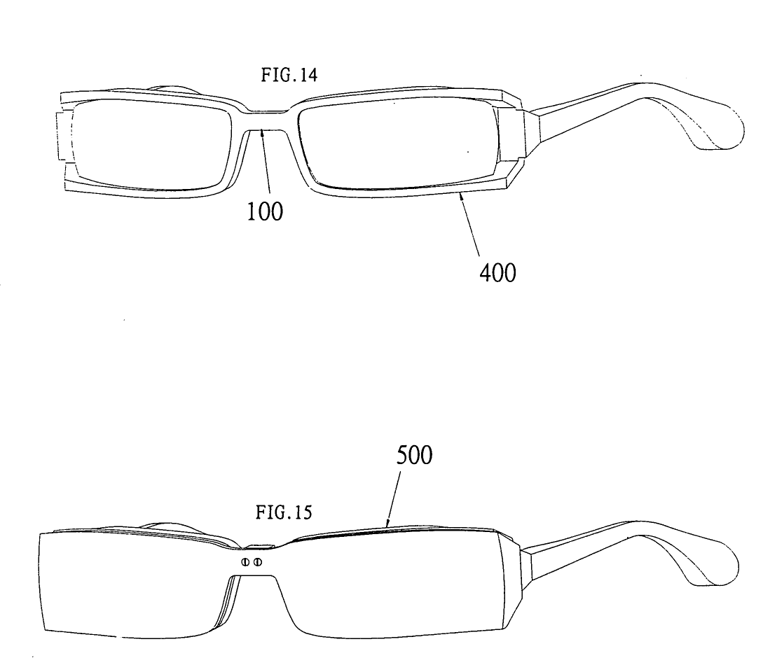

FIG. 14 is a front perspective view of the primary spectacle frame 400. It can be seen that the built-in recesses of the bridge 100 are not visible from a front view of the primary frame 400.

FIG. 15 is a front perspective view of the spectacle assembly 500. As the auxiliary eyeglasses 260 are a one-piece sunshield lenses which contain no rim-wire, and/or any metal appendages (clips, hooks, magnets . . . ) constructed thereon or around the edges of the lenses, the appearances of frame 400 as seen in FIG. 14 and spectacle assembly 500 as seen in FIG. 15 stay clean and neat. Individuality of the respective eyeglasses of FIG. 14 and FIG. 15 is maintained due to the non-existence of those conventional extra attaching accessories. Appearance of the primary frame 400 stays as its original with or without the attachment of the auxiliary eyeglasses; while the spectacle assembly 500 will look like a pair of original sunglasses with the attachment of the one-piece sunshield lenses 260.

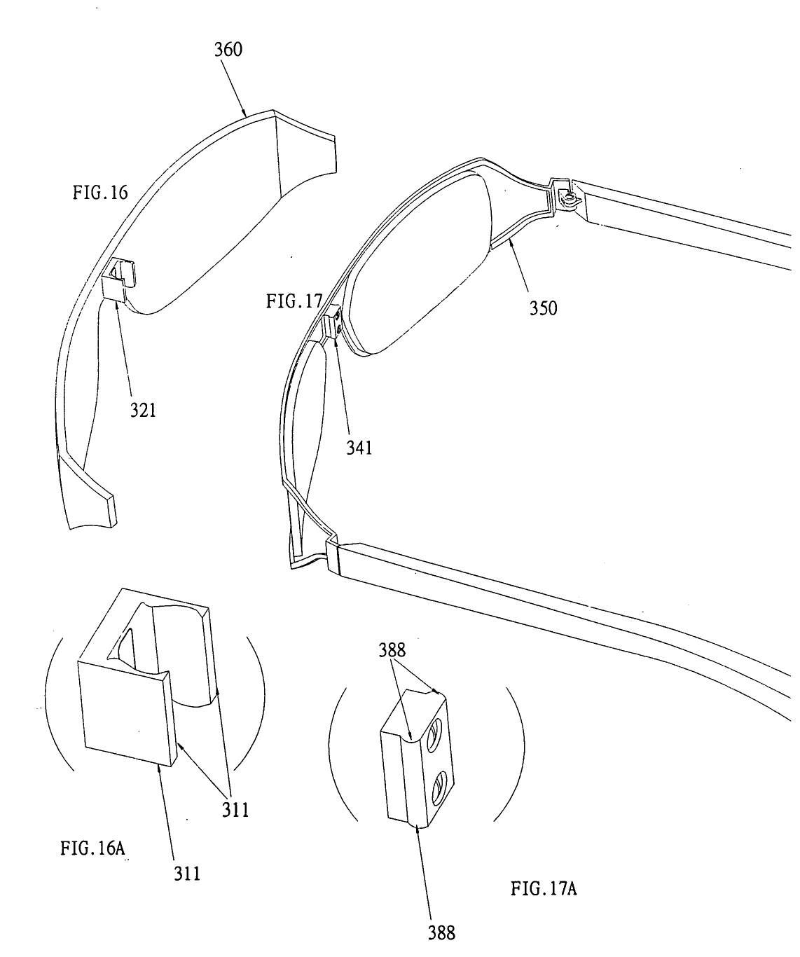

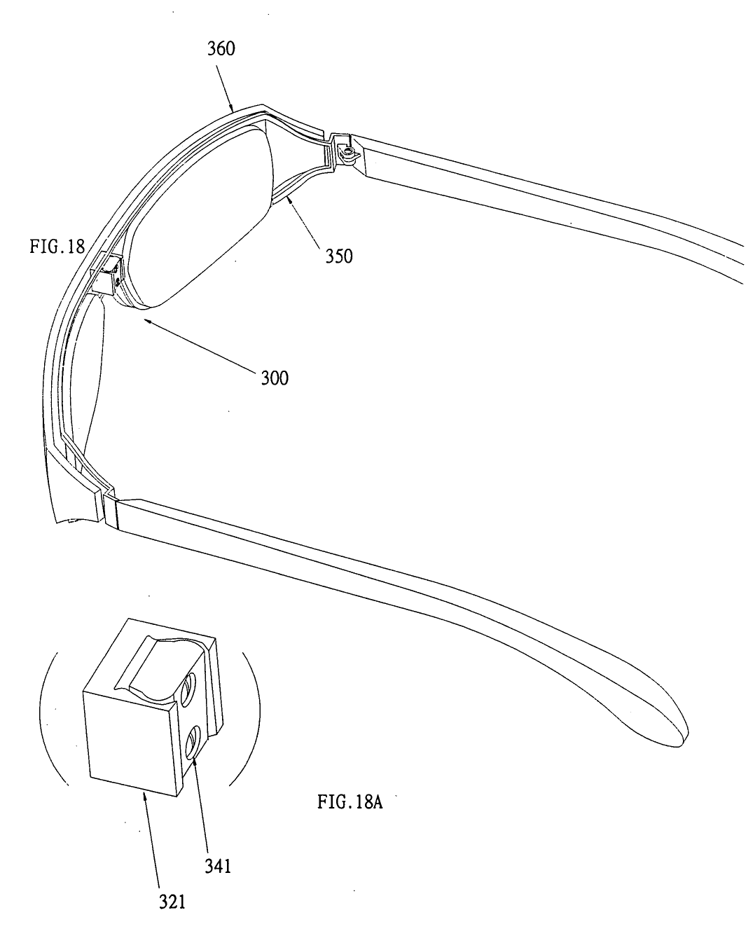

FIGS. 16-18A show an eyeglass assembly 300 according to a further preferred embodiment of the present invention. This embodiment is similar to that shown in FIGS. 1-5, in that a pair of auxiliary eyeglasses 360 according to the present invention is provided with a plastic resilient grip 321, for snap-fitting with a complementary plastic socket 341 of a primary spectacle frame 350. The present assembly 300 differs from the embodiment shown in FIGS. 1-5 in that the grip 321 has two resilient legs 311, 311, with oppositely-facing vertically-extending inner surfaces which are concave relative to each other, and the socket 314 has two vertically-extending outwardly-bulging (i.e. convex) oppositely-facing outer surfaces 388.

Along the bridge of the primary spectacle frame 350 and on each side of the socket 341 is an aperture, through each of which a respective leg 311 may be extended. For engaging the pair of auxiliary eyeglasses 360 with the spectacle frame 350, the legs 311 are inserted through a respective aperture on the bridge of the frame 350, so as to enable the inner surfaces of the legs 311 to detachably engage the outer surfaces 388 of the socket 341 in a snap-fitting manner, as shown in FIG. 18A. Because of the resilience of the legs 311, the pair of auxiliary eyeglasses 360 may be detached from the primary spectacle frame 350 by pulling the two apart from each other, or by firstly moving one of the legs 311 away from the outer surface of the socket 341 with which it is engaged, so as to disengage the grip-321 from the socket 341.

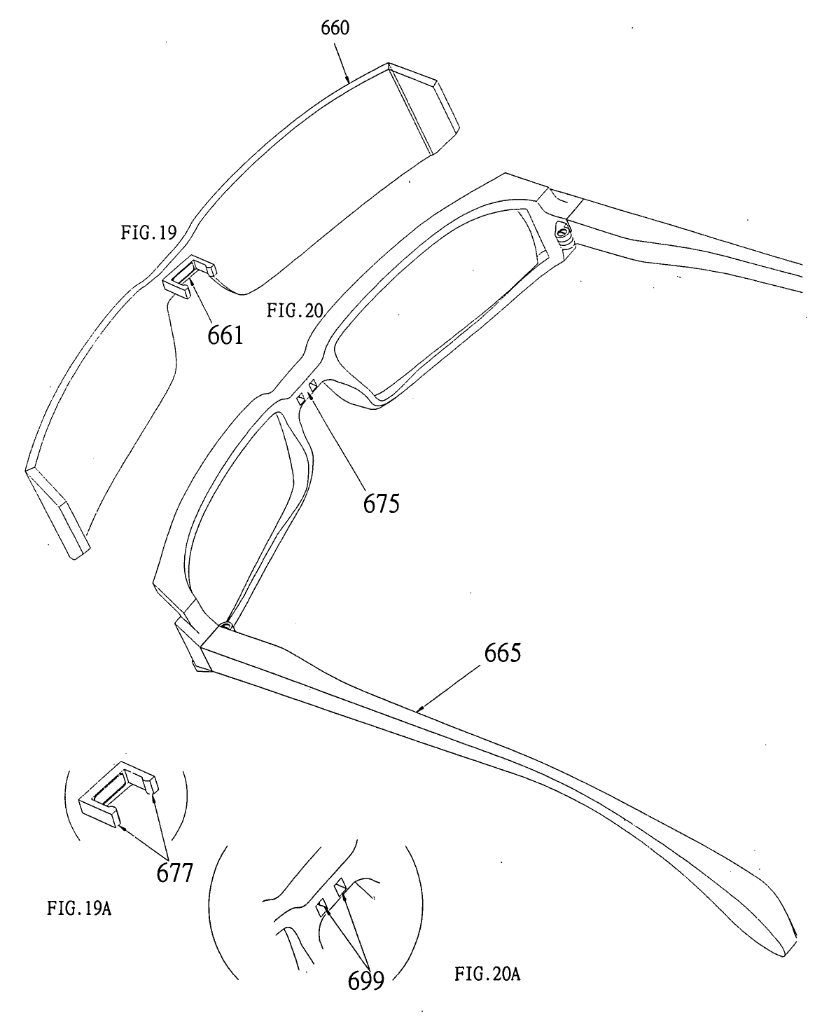

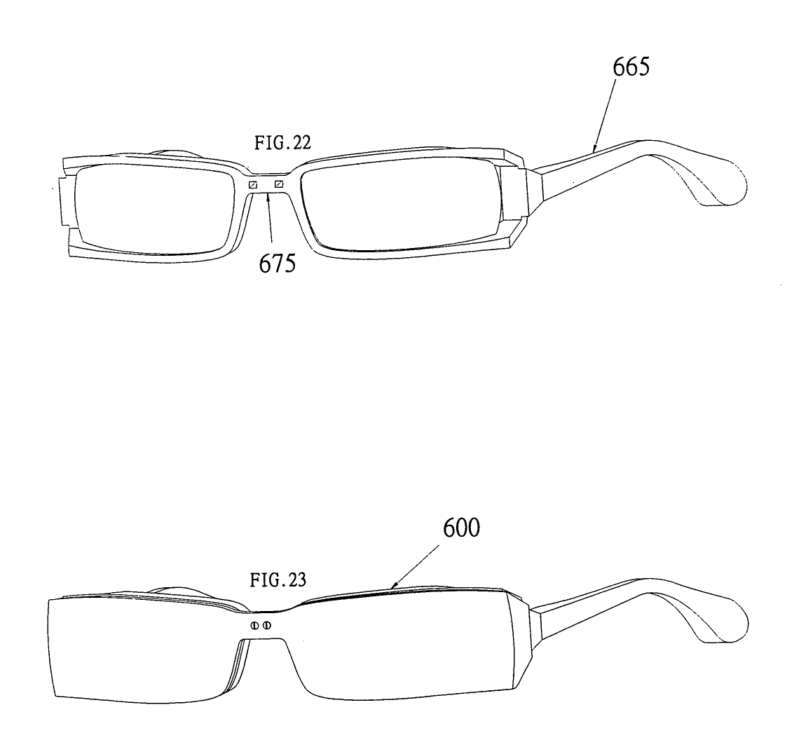

A further eyeglass assembly 600 according to a yet further preferred embodiment of the present invention is shown in FIGS. 19-23. The eyeglass assembly 600 includes a pair of auxiliary eyeglasses 660 and a primary spectacle frame 665. Provided on a rear side and near the nasal region of the pair of auxiliary eyeglasses 660 is a grip 661 comprising a pair of resilient legs 677 which extend away from the pair of auxiliary eyeglasses 660. Along a bridge 675 of the primary spectacle frame 665 are a pair of generally rectangular holes 699 each sized and configured to receive a respective leg 677 therethrough. It can be seen that the free end of the respective leg 677 is in hook shape.

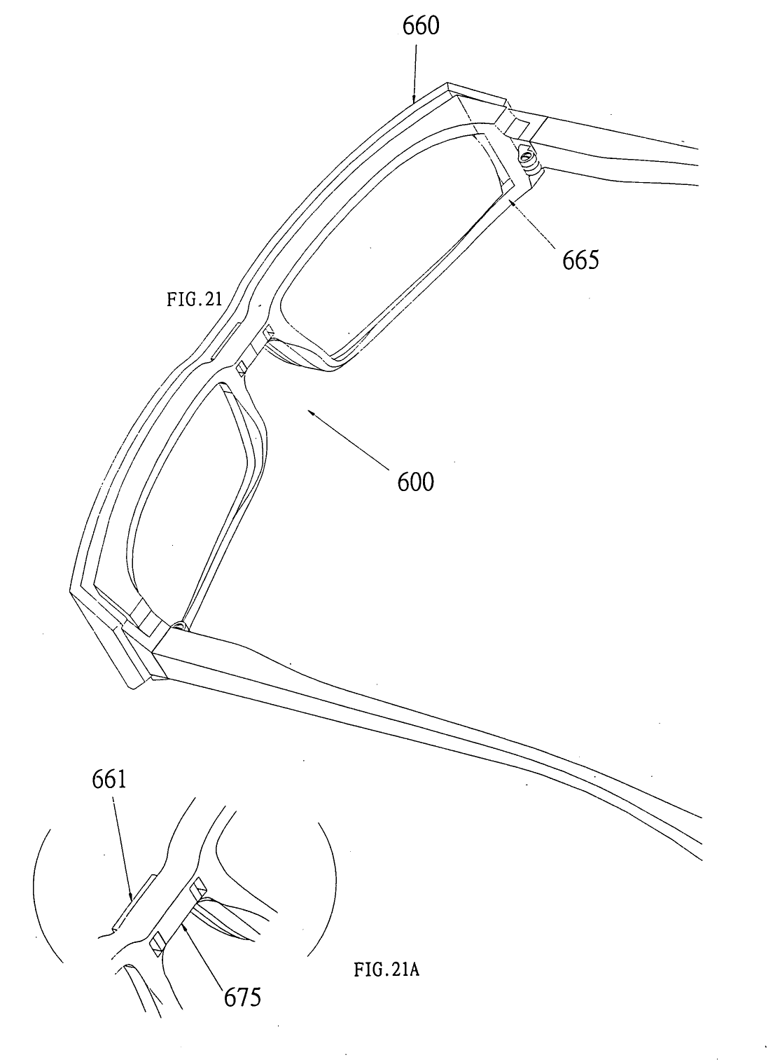

To engage the pair of auxiliary eyeglasses 660 with the primary spectacle frame 665, the pair of legs 677 of the grip 661 are each received through a respective hole 699, until the hook-shaped free end of the respective leg 677 is locked against the hole 699, as shown in FIG. 21A. To disengage the pair of auxiliary eyeglasses 660 from the primary spectacle frame 665, the free ends of the legs 677 are moved away from each other, to allow the legs 677 to be retrieved from the holes 699.

As the present invention involves no metal appendages placing on the temporal area and rim wire support is unnecessary, side shield and aerodynamic design are possible in the present examples. Design of eyewear is made more flexible and diversified due to the exclusion of a double set of rim wire, conventional hooks, clips, temple extension devices and other attaching accessories.

Although the present invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A spectacle assembly including:
a spectacle frame; and
at least one pair of auxiliary eyeglasses releasably attachable with said spectacle frame;
wherein said pair of auxiliary eyeglasses include at least a first resilient engagement member snap-fittable with said spectacle frame.

2. An assembly according to claim 1 wherein said first engagement member is made at least of a plastics material.

3. An assembly according to claim 1 wherein said first engagement member is secured to said pair of auxiliary eyeglasses by at least a screw.

4. An assembly according to claim 1 wherein said first engagement member is provided at or adjacent a nasal area on a rear side of said auxiliary eyeglasses.

5. An assembly according to claim 1 wherein said first engagement member is releasably engageable with a second engagement member on said spectacle frame.

6. An assembly according to claim 1 wherein said first engagement member is snap-fittable with upper and lower sides of a bridge portion of said spectacle frame.

7. An assembly according to claim 1 wherein said first engagement member includes a plurality of resilient leg members.

8. An assembly according to claim 5 wherein said first engagement member includes a plurality of surfaces releasably engageable with a plurality of surfaces of said second engagement member.

9. An assembly according to claim 5 wherein said second engagement member is provided at or adjacent behind a bridge portion of said spectacle frame.

10. An assembly according to claim 5 wherein said second engagement member is confined behind a bridge portion of said spectacle frame.

11. An assembly according to claim 5 wherein said second engagement member is secured to said spectacle frame by at least one screw.

12. An assembly according to claim 5 wherein said second engagement member is made at least of a plastics material.

13. An assembly according to claim 7 wherein said leg members are disposed one above another.

14. An assembly according to claim 7 wherein said leg members are disposed side by side with each other.

15. An assembly according to claim 7 wherein said leg members extend from a base of said first engagement member.

16. An assembly according to claim 7 wherein a bridge portion of said spectacle frame is provided with at least one aperture for receiving at least one of said leg members.

17. An assembly according to claim 8 wherein said surfaces of said second engagement member are disposed one above another.

18. An assembly according to claim 8 wherein said surfaces of said second engagement member are disposed side by side with each other.

19. An assembly according to claim 8 wherein said surfaces of said first engagement member are convex.

20. An assembly according to claim 8 wherein said surfaces of said first engagement member are concave.

21. An assembly according to claim 8 wherein said surfaces of said second engagement member are convex.

22. An assembly according to claim 8 wherein said surfaces of said second engagement member are concave.

23. An assembly according to claim 1 wherein a bridge portion of said spectacle frame is provided with at least one aperture for receiving at least part of said first resilient engagement member.

24. An assembly according to claim 1 wherein said pair of auxiliary eyeglasses is of a one-piece construction shield lenses.

25. A method of forming a spectacle assembly, including the steps of:
providing a spectacle frame;
providing at least one pair of auxiliary eyeglasses releasably attachable with said spectacle frame; and
providing a first resilient engagement member on said pair of auxiliary eyeglasses for snap-fitting with said spectacle frame.

26. A method according to claim 25 including a step of forming said first engagement member at least of a plastics material.

27. A method according to claim 25 including a step of securing said first engagement member to said pair of auxiliary eyeglasses by at least a screw.

28. A method according to claim 25 including a step of providing said first engagement member at or adjacent a nasal area on a rear side of said auxiliary eyeglasses.

29. A method according to claim 25 including a step of providing a second engagement member on said spectacle frame for releasable engagement with said first engagement member.

30. A method according to claim 25 wherein said first resilient engagement member is snap-fittable with upper and lower sides of a bridge portion of said spectacle frame.

31. A method according to claim 25 wherein said first resilient engagement member includes a plurality of resilient leg members.

32. A method according to claim 29 wherein said first engagement member includes a plurality of surfaces releasably engageable with a plurality of surfaces of said second engagement member.

33. A method according to claim 29 including a step of providing said second engagement member at or adjacent behind a bridge portion of said spectacle frame.

34. A method according to claim 29 including a step of confining said second engagement member behind a bridge portion of said spectacle frame.

35. A method according to claim 29 including a step of securing said second engagement member to said spectacle frame by at least one screw.

36. A method according to claim 29 including a step of forming said second engagement member at least of a plastics material.

37. A method according to claim 31 wherein said leg members are disposed one above another.

38. A method according to claim 31 wherein said leg members are disposed side by side with each other.

39. A method according to claim 31 wherein said leg members extend from a base of said first engagement member.

40. A method according to claim 31 including a step of providing at least one aperture on a bridge portion of said spectacle frame for receiving at least one of said leg members.

41. A method according to claim 32 wherein said surfaces of said second engagement member are disposed one above another.

42. A method according to claim 32 wherein said surfaces of said second engagement member are disposed side by side with each other.

43. A method according to claim 32 wherein said surfaces of said first engagement member are convex.

44. A method according to claim 32 wherein said surfaces of said first engagement member are concave.

45. A method according to claim 32 wherein said surfaces of said second engagement member are convex.

46. A method according to claim 32 wherein said surfaces of said second engagement member are concave.

47. A method according to claim 25 wherein said pair of auxiliary eyeglasses is of a one-piece construction shield lenses.

48. A method according to claim 25 including a step of providing at least one aperture on a bridge portion of said spectacle frame for receiving at least part of said first resilient engagement member.
